(19) United States
(12) Patent Application Publication
(10) Pub. No.: US 2016/0345607 A1
(43) Pub. Date: Dec. 1, 2016

(54) Livestock Feed Ingredient And Methods Of Producing The Same From Livestock Manure

(71) Applicant: From The Earth, LLC, Leawood, KS (US)

(72) Inventor: Jeffrey David NOLAND, Leawood, KS (US)

(73) Assignees: From The Earth, LLC, Leawood, KS (US); From The Earth, LLC, Leawood, KS (US)

(21) Appl. No.: 15/164,484

(22) Filed: May 25, 2016

Related U.S. Application Data
(60) Provisional application No. 62/166,187, filed on May 26, 2015.

(51) Int. Cl. A23K 10/26

(52) U.S. Cl. CPC A23K 10/26

(57) ABSTRACT

Methods for producing feed ingredients for livestock (e.g., poultry, ruminants) from livestock manure which has been thermally reacted are provided herein. Feed ingredient compositions for livestock are also provided herein.

### FIELD OF THE INVENTION

This invention relates to a feed ingredient for livestock and methods of producing the same from livestock manure.

### BACKGROUND OF THE INVENTION

Animal manure typically contains various mineral nutrients, such as phosphorous, calcium and potassium. Thus, raw or composted manure historically has been land-applied for crop fertilization, blended into feed for different animals, or simply consumed by animals in raw form. However, a challenge in using manure is that its composition is typically unbalanced. For example, in fertilizer applications, manure may be applied for the benefit of one mineral nutrient, such as phosphorus, but over application of another nutrient, such as nitrogen, can also occur. This over application of nitrogen can lead to significant water pollution issues in streams and estuaries. Further, storage and transportation of manure can lead to the spread of disease, impacting animals and humans. Additionally, since manure is typically high in moisture, it can be difficult and inefficient to transport. Such challenges associated with manure storage and transportation can result in excess amounts of manure near population centers where animals, particularly poultry, are fed.

Manure burning has long been a way to solve the excess manure problem. However, this practice often results in local air pollution and a loss of nutrients, including phosphorus, with low points of melting and vaporization. Thus there is a need for more effective methods to process manure such that the loss of nutrients is minimized and that a product is produced with sufficient nutrient levels rendering it useful as a feed ingredient for livestock.

### SUMMARY OF THE INVENTION

It has been found that livestock manure (e.g. poultry manure) can be thermally reacted (e.g., in a gasification process) to produce a manure ash product with sufficient mineral nutrients which may be suitable for use as a livestock feed ingredient (e.g., poultry feed ingredient, ruminant feed ingredient) following optional further processing to adjust pH and/or mineral amounts.

Thus, in one aspect, embodiments of the invention provide a method for producing a feed ingredient for livestock. The method comprises: thermally reacting livestock manure to produce a manure ash product comprising calcium phosphate; and determining pH of the manure ash product to produce the feed ingredient comprising calcium phosphate.

In still another aspect, embodiments of the invention provide a method for producing a feed ingredient for livestock. The method comprises determining pH of a manure ash product comprising calcium phosphate to produce the feed ingredient comprising calcium phosphate.

In still another aspect, embodiments of the invention provide a method for producing a feed ingredient for livestock. The method comprises contacting a manure ash product having a pH of greater than about 10 with at least one neutralizing agent in a sufficient amount to produce the feed ingredient for livestock having a pH of less than or equal to about 10, wherein the manure ash product is produced from a thermal reaction of livestock manure and wherein the feed ingredient comprises calcium in an amount of at least about 10 wt. %; and phosphorous in an amount of at least about 5.0 wt.

In still another aspect, embodiments of the invention provide a feed ingredient produced by the methods described herein.

In still another aspect, embodiments of the invention provide a feed ingredient for livestock comprising: calcium phosphate; calcium in an amount of at least about 10 wt. %; phosphorous in an amount of at least about 5.0 wt. %; wherein the feed ingredient has a pH of less than about 13.

Other embodiments, including particular aspects of the embodiments summarized above, will be evident from the detailed description that follows.

### BRIEF DESCRIPTION OF THE DRAWINGS

FIG. 1 illustrates a process flow diagram of a method for producing a livestock feed ingredient.

### DETAILED DESCRIPTION OF THE INVENTION

In various aspects of the invention, methods for methods for producing a feed ingredient for livestock and feed ingredients for livestock are provided.

### I. DEFINITIONS

The term “and/or” as used in a phrase such as “A and/or B” herein is intended to include “A and B”, “A or B”, “A”, and “B”.

The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters.

In addition, disclosure of ranges includes disclosure of all values and further divided ranges within the entire range, including endpoints and sub-ranges given for the ranges.

As used herein, the term “feed ingredient for livestock” refers to a material which meets at least a portion of the nutritional requirements for livestock (e.g., poultry, ruminants, etc.) and which may be further combined with other ingredients (e.g. corn meal, soy bean meal, calcium carbonate, magnesium oxide, other calcium phosphates) into a livestock feed product.

As used herein, the term “livestock” refers to all domesticated animals, which may be reared or raised in an agricultural setting to make products such as food or fiber, or for its labor. Examples of livestock include, but are not limited to poultry, horses, swine, ruminants (e.g. all varieties of cattle such as dairy cows and beef cattle), and rabbits.

As used herein, the term “poultry” refers to all forms of any fowl kept, harvested, or domesticated for meat or eggs, including but not limited to chicken (e.g., egg-laying chickens, broiler chickens), turkey, ostrich, game hen, squab, guinea fowl, pheasant, quail, duck, goose, emu, or the like.

As used herein, the term “ruminant” refers to a mammal of the order Artiodactyla that digests plant-based food by initially softening it within the animal's first stomach, then regurgitating the semi-digested mass, also known as cud, and chewing it again. The ruminant may have a complex 3-chamber or 4-chamber stomach. The process of rechewing the cud to further break down plant matter and stimulate digestion is called “ruminating.” Ruminants include, but are not limited to cattle (e.g., dairy cows, beef cows), goats, sheep, giraffes, bison, moose, elk, yaks, water buffalo, deer, alpacas, camels, llamas, wildebeest, antelope, pronghorn, and nilgai.

As used herein, the term “livestock manure” refers to the feces of livestock. The livestock manure may further comprise urine from the livestock. The livestock manure may or may not be blended with amounts of absorbent material, such as but not limited to bedding (e.g., straw, wood shavings, sand, grass clippings, leaves, paper, etc.). If present, the absorbent material may be present in the manure in amount of less than about 50 wt. %, less than about 30 wt. %, less than about 20 wt. %, less than about 10 wt. % or less than about 5.0 wt. %.

### II. METHODS FOR PRODUCING A LIVESTOCK FEED INGREDIENT

In various aspects, methods for producing a feed ingredient for livestock are provided.

A. Thermally Reacting Livestock Manure

The method can comprise thermally reacting livestock manure to produce a manure ash product. As understood herein, thermally reacting includes thermal reactions and thermochemical reactions as understood in the art. The livestock manure may comprise poultry manure or other manure suitable for mineral recovery, such as ruminant manure (e.g., cow manure). In particular, the livestock manure comprises poultry manure. The livestock manure may be thermally reacted via processes such as, but not limited to gasification, combustion, torrefaction, pyrolysis, and a combination thereof.

1. Gasification

The gasification process may be a staged combustion process wherein livestock manure is heated to the point of volatilizing organic compounds in livestock manure. The organic compounds may comprise the carbon-containing compounds (e.g., C₁-C₁₀ hydrocarbons) present in the livestock manure. The gasification process may be performed under sub-stoichiometric conditions (e.g. conditions under which oxygen concentration is sufficient to complete the combustion reaction) by controlling the oxygen concentration of the reaction atmosphere. Pre-heated air (e.g. ambient air heat to between about 200° F. and about 400° F.) may be mixed with flue gas under sufficient conditions needed to produce synthesized gas (syngas). The synthesized gas may comprise a mixture of carbon monoxide, methane, and other hydrocarbon compounds (e.g., C₁-C₁₀ hydrocarbons). The flue gas may be any suitable gas with a low oxygen content. The flue gas may be a product of combustion from the gasification process. For example, the flue gas may comprise oxygen in amount of less than or equal to about 7.0 wt. %, less than or equal to about 5.0 wt. %, less than or equal to about 4.0 wt. %, less than or equal to about 3.5 wt. % or less than or equal to about 2.0 wt. %. The synthesized gas may be drawn away from the gasification area via any suitable downstream process, such as oxidization or distillation.

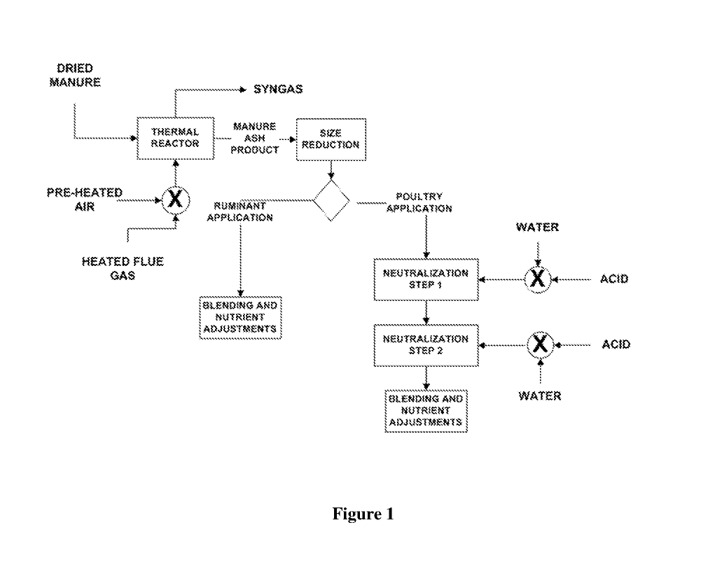

In particular, livestock manure may be fed to a thermal reactor, such as a gasifier, as shown in FIG. 1. Prior to introduction into the thermal reactor (e.g., gasifier), the livestock manure may be dried to have a moisture content (e.g. water content) of less than or equal to about 30 wt. %, less than or equal to about 20 wt. %, less than or equal to about 10 wt. %, less than or equal to about 5.0 wt. %, or less than or equal to about 1.0 wt. %. Additionally or alternatively, the manure may have a moisture content of about 1.0 wt. % to about 30 wt. %, about 1.0 wt. % to about 20 wt. %, about 5.0 wt. % to about 20 wt. %, about 1.0 wt. % to about 10 wt. %, or about 1.0% to about 5.0 wt. %.

The gasifier may comprise one or more combustion zones where the livestock manure may be contacted with air and flue gas to produce a manure ash product and synthesis gas. The combustions zones may be present in the same and/or different reactors. The synthesis gas may be drawn out of the combustion zones by any suitable method, e.g., via an induced-draft fan. In particular, the gasifier may comprise 1 combustion, 2 combustion zones, 3 combustion zones, 4 combustions zones, 5 combustions zones, 6 combustion zones, 7 combustion zones, 8 combustions zone, 9 combustion zones or 10 combustions zones. Additionally or alternatively, the gasifier may comprise from 1 to 10 combustion zones, from 1 to 8 combustion zones or 2 to 6 combustion zones.

The air and flue gas may enter a combustion zone through any permeable surface, such as but not limited to a grated or perforated surface, and contact the livestock manure present on the permeable surface. The air may be preheated to at least about 200° F., at least about 225° F., at least about 250° F., at least about 275° F., at least about 300° F., at least about 325° F., at least about 350° F., at least about 375° F., or at least about 400° F. Additionally or alternatively, the air may be preheated at about 200° F. to about 400° F., about 200° F. to about 300° F., about 200° F. to about 275° F. or about 200° F. to about 250° F. The flue gas may be preheated to at least about 200° F., at least about 230° F., at least about 250° F., at least about 275° F., at least about 300° F., at least about 325° F., at least about 350° F., at least about 375° F., or at least about 400° F. Additionally or alternatively, the flue gas may be preheated at about 200° F. to about 400° F., about 200° F. to about 300° F., about 200° F. to about 275° F. or about 200° F. to about 230° F. In particular, the flue gas comprises oxygen in amount less than or equal to about 7.0 wt. %, less than or equal to about 5.0 wt. %, less than or equal to about 3.5 wt. %, or less than or equal to about 1.0 wt. %. The ratio of the flue gas and air can accelerate or retard the combustion reaction within each combustion zone. Preferably, substantially all of the carbon-containing compounds may be removed from the livestock manure to produce a manure ash product with low amounts of carbon-containing compounds, e.g., less than 5 wt. %, less than 3 wt. %, less than 1 wt. %. As shown in FIG. 1, the pre-heated air and heated flue gas may be mixed together prior to entering a thermal reactor (e.g., gasifier). The pre-heated air and heated flue gas contacts the livestock manure and may produce syngas and the manure ash product.

In various aspects, the thermal reaction (e.g., gasification) in a combustion zone may be performed at a temperature of at least about 500° F., at least about 600° F., at least about 700° F., at least about 800° F., at least about 900° F., at least about 1000° F., at least about 1100° F., at least about 1200° F., at least about 1300° F., at least about 1400° F., or about 1500° F. In particular, the temperature may be at least about 600° F. to avoid production of dioxins and furans. Additionally or alternatively, the thermal reaction (e.g., gasification) in the combustion zone may be performed at a temperature of about 500° F. to about 1500° F., about 500° F. to about 1500° F., about 600° F. to about 1500° F., about 600° F. to about 1400° F., about 600° F. to about 1300° F., about 600° F. to about 1200° F. or about 600° F. to about 1000° F. In particular, the thermal reaction (e.g., gasification) in the combustion zone may be performed at a temperature of about 600° F. to about 1500° F., about 600° F. to about 1300° F., about 600° F. to about 1200° F. or about 600° F. to about 1000° F.

2. Other Thermal Reaction Processes

Other suitable thermal reaction process contemplated for converting livestock manure to a manure ash product include, but are not limited to stoichiometric combustion, torrefaction and pyrolysis. During stoichiometric combustion, substantially all of the carbon, hydrogen, and sulfur may be removed from the livestock manure via a combustion reaction in a thermal reactor (e.g., fuel bed) to produce heat and light. During stoichiometric combustion, sufficient heat may be provided to volatilize organic compounds in the livestock manure and sufficient oxygen may be provided to allow combustion to be substantially completed as defined by the depletion of carbon, hydrogen, and sulfur in the thermal reactor (e.g., fuel bed). Process temperatures during stoichiometric combustion of livestock manure may be at least about 2000° F. and up to about 3000° F. It may produce a carbon-dense residue as well.

Torrefaction of the livestock manure may be carried out under atmospheric conditions (e.g., about 80 kPa to about 110 kPa) and in the absence of oxygen. Typical process temperatures for torrefaction are between about 200° C. and about 320° C.

Pyrolysis, which involves a thermochemical decomposition of the livestock manure may be performed under atmospheric conditions (e.g., about 80 kPa to about 110 kPa) and at elevated temperatures of about 300° C. to about 650° C. The torrefaction process more thoroughly decomposes the cellular structure of biomass material present in the livestock manure when compared to torrefaction. It may produce a carbon-dense residue as well.

In another embodiment, a process for thermally reacting livestock manure is provided herein. The process may comprise providing livestock manure as described herein to a thermal reactor to produce a manure product as described herein. The livestock manure may undergo a thermal reaction process as described herein in the thermal reactor.

B. Manure Ash Product

It has been discovered that thermally reacting livestock manure, for example in a gasification process as described above, may result in a manure ash product with advantageous amounts of minerals such that the manure ash product may be used as a feed ingredient for livestock with or without further processing depending on the pH of the manure ash product. As used herein, the term “manure ash product” refers to a substantially solid material resulting from a thermal reaction of livestock manure where a substantial amount of the carbon in the livestock manure has been reacted and removed.

In various aspects, the manure ash product may comprise various minerals in varying amounts. Suitable minerals include, but are not limited to calcium, chloride, magnesium, phosphorus, potassium, sodium, sulfur and combinations thereof.

The manure ash product may comprise calcium in an amount of at least about 10 wt. %, at least about 11 wt. %, at least about 20 wt. %, at least about 30 wt. %, or at least about 40 wt. %. Additionally or alternatively, the manure ash product may comprise calcium in an amount of about 10 wt. % to about 40 wt. %, about 11 wt. % to about 40 wt. %, about 20 wt. % to about 40 wt. % or about 30 wt. % to about 40 wt. %.

Additionally or alternatively, the manure ash product may comprise phosphorus in an amount of at least about 5.0 wt. %, at least about 6.0 wt. %, at least about 7.0 wt. %, at least about 10 wt. %, at least about 12 wt. % or at least about 15 wt. %. Additionally or alternatively, the manure ash product may comprise phosphorus in an amount of about 5.0 wt. % to about 15 wt. %, about 6.0 wt. % to about 15 wt. %, about 5.0 wt. % to about 12 wt. % or about 5.0 wt. % to about 10 wt. %.

Additionally or alternatively, the manure ash product may comprise magnesium in an amount of at least about 1.0 wt. %, at least about 3.0 wt. %, at least about 5.0 wt. %, at least about 7.0 wt. %, or at least about 10 wt. %. Additionally or alternatively, the manure ash product may comprise magnesium in an amount of about 1.0 wt. % to about 10 wt. %, about 1.0 wt. % to about 7.0 wt. % or about 1.0 wt. % to about 5.0 wt. %.

Additionally or alternatively, the manure ash product may comprise potassium in an amount of at least about 3.0 wt. %, at least about 5.0 wt. %, at least about 7.0 wt. %, at least about 7.5 wt. % at least about 10 wt. %, or at least about 12 wt. %. Additionally or alternatively, the manure ash product may comprise potassium in an amount of about 3.0 wt. % to about 12 wt. %, about 3.0 wt. % to about 10 wt. %, about 5.0 wt. % to about 10 wt. % or about 7.5 wt. % to about 10 wt. %

Additionally or alternatively, the manure ash product may comprise chloride in an amount of at least about 1.0 wt. %, at least about 3.0 wt. %, at least about 5.0 wt. %, at least about 7.0 wt. %, or at least about 10 wt. %. Additionally or alternatively, the manure ash product may comprise chloride in an amount of about 1.0 wt. % to about 10 wt. %, about 1.0 wt. % to about 7.0 wt. % or about 1.0 wt. % to about 5.0 wt. %.

Additionally or alternatively, the manure ash product may comprise sodium in an amount of at least about 0.50 wt. %, at least about 1.0 wt. %, at least about 3.0 wt. %, at least about 5.0 wt. %, or at least about 7.0 wt. %. Additionally or alternatively, the manure ash product may comprise sodium in an amount of about 0.50 wt. % to about 7.0 wt. %, about 0.50 wt. % to about 5.0 wt. % or about 1.0 wt. % to about 3.0 wt. %.

Additionally or alternatively, the manure ash product may comprise a low amount of sulfur, e.g., less than or equal to about 5.0 wt. %, less than or equal to about 3.0 wt. %, less than or equal to about 1.0 wt. %, or less than or equal to about 0.50 wt. % of. Additionally or alternatively, the manure ash product may comprise sulfur in an amount of about 0.50 wt. % to about 5.0 wt. %, about 0.50 wt. % to about 3.0 wt. % or about 0.50 wt. % to about 1.0 wt. %.

Additionally or alternatively, the manure ash product may comprise a low amount of carbon, e.g. less than or equal to about 10 wt. %, less than or equal to about 7.0 wt. %, less than or equal to about 5.0 wt. %, or less than or equal to about 3.0 wt. %. Additionally or alternatively, the manure ash product may comprise carbon in an amount of about 3.0 wt. % to about 10 wt. %, about 3.0 wt. % to about 7.0 wt. % or about 3.0 wt. % to about 5.0 wt. %.

In a particular embodiment, the manure ash product comprises calcium in an amount of at least about 10 wt. %, phosphorus in an amount of at least about 5.0 wt. %, and/or potassium in an amount of at least about 5.0 wt. %.

The above-described minerals may be present in various mineral compounds in the manure ash product. Suitable mineral compounds include, but are not limited to calcium-containing compounds, phosphorus-containing compounds, potassium-containing compounds, magnesium-containing compounds, and combinations thereof. Non-limiting examples of the mineral compounds include calcium phosphates (e.g., Ca₅(PO₄)₃(OH)₂ (hydroxyapatite), Ca(H₂PO₄)₂ (monocalcium phosphate), CaHPO₄ (dicalcium phosphate), Ca₃(PO₄)₂ (tricalcium phosphate)), calcium carbonates (e.g. CaCO₃ (calcite)), sorosilicates (e.g., Ca₂MgSi₂O₇ (akermanite)), potassium chlorides (e.g., KCl (sylvite)), potassium sulfates (e.g., K₂SO₄ (arcanite)), calcium oxides (e.g., CaO (lime)), magnesium oxides (e.g., MgO (periclase)), calcium hydroxide (e.g., Ca(OH)₂ (portlandite)), potassium hydroxide (e.g., KOH), potassium carbonates (e.g., K₂CO₃) and combinations thereof.

Calcium phosphate (e.g., Ca₅(PO₄)₃(OH)₂, Ca(H₂PO₄)₂, CaHPO₄, Ca₃(PO₄)₂) may be present in the manure ash product in an amount of at least about 10 wt. %, at least about 20 wt. %, at least about 30 wt. %, at least about 35 wt. %, at least about 40 wt. %, at least about 45 wt. % or at least about 50 wt. %. Additionally or alternatively, calcium phosphate (e.g., Ca₅(PO₄)₃(OH)₂, Ca(H₂PO₄)₂, CaHPO₄, Ca₃(PO₄)₂) may be present in the manure ash product in an amount of about 10 wt. % to about 50 wt. %, about 20 wt. % to about 45 wt. %, about 30 wt. % to about 45 wt. %, about 35 wt. % to about 45 wt. %, or about 35 wt. % to about 40 wt. %. In particular, calcium phosphate (e.g., Ca₅(PO₄)₃(OH)₂, Ca(H₂PO₄)₂, CaHPO₄, Ca₃(PO₄)₂) may be present in the manure ash product in accordance with American Feed Control Officials (AFFCO) definition 57.134 and/or 21 C.F.R. §182.8217. In accordance with AFFCO definition 57.134 the calcium phosphate may be considered calcined, fused, precipitated or reacted. Further, a suitable amount of phosphoric acid may be added to the manure ash product to achieve calcium phosphate in accordance with AFFCO definition 57.134 and/or 21 C.F.R. §182.8217.

Additionally or alternatively, calcium carbonate (e.g. CaCO₃) may be present in the manure ash product in an amount of at least about 20 wt. %, at least about 25 wt. %, at least about 30 wt. %, at least about 35 wt. % or at least about 40 wt. %. Additionally or alternatively, calcium carbonate (e.g. CaCO₃) may be present in the manure ash product in an amount of about 20 wt. % to about 40 wt. %, about 20 wt. % to about 35 wt. %, or about 25 wt. % to about 35 wt. %.

Additionally or alternatively, sorosilicate (e.g., Ca₂MgSi₂O₇) may be present in the manure ash product in an amount of at least about 1.0 wt. %, at least about 3.0 wt. %, at least about 5.0 wt. %, at least about 7.0 wt. % or at least about 10 wt. %. Additionally or alternatively, sorosilicate (e.g., Ca₂MgSi₂O₇) may be present in the manure ash product in an amount of about 1.0 wt. % to about 10 wt. %, about 1.0 wt. % to about 7.0 wt. %, or about 1.0 wt. % to about 5.0 wt. %.

Additionally or alternatively, potassium chloride (e.g., KCl) may be present in the manure ash product in an amount of at least about 1.0 wt. %, at least about 3.0 wt. %, at least about 5.0 wt. %, at least about 7.0 wt. % or at least about 10 wt. %. Additionally or alternatively, potassium chloride (e.g., KCl) may be present in the manure ash product in an amount of about 1.0 wt. % to about 10 wt. %, about 3.0 wt. % to about 10 wt. %, or about 3.0 wt. % to about 7.0 wt. %.

Additionally or alternatively, potassium sulfate (e.g., K₂SO₄) may be present in the manure ash product in an amount of at least about 0.50 wt. %, at least about 1.0 wt. %, at least about 3.0 wt. %, or at least about 5.0 wt. %. Additionally or alternatively, potassium sulfate (e.g., K₂SO₄) may be present in the manure ash product in an amount of about 0.50 wt. % to about 5.0 wt. %, about 0.50 wt. % to about 3.0 wt. %, or about 1.0 wt. % to about 3.0 wt. %.

Additionally or alternatively, calcium oxide (e.g., CaO) may be present in the manure ash product in an amount of at least about 3.0 wt. %, at least about 5.0 wt. %, at least about 7.0 wt. %, at least about 10 wt. % or at least about 15 wt. %. Additionally or alternatively, calcium oxide (e.g., CaO) may be present in the manure ash product in an amount of about 3.0 wt. % to about 15 wt. %, about 5.0 wt. % to about 15 wt. %, or about 7.0 wt. % to about 15 wt. %.

Additionally or alternatively, magnesium oxide (e.g., MgO) may be present in the manure ash product in an amount of at least about 1.0 wt. %, at least about 5.0 wt. %, at least about 7.0 wt. %, or at least about 10 wt. %. Additionally or alternatively, magnesium oxide (e.g., MgO) may be present in the manure ash product in an amount of about 1.0 wt. % to about 10 wt. %, about 1.0 wt. % to about 7.0 wt. %, or about 1.0 wt. % to about 5.0 wt. %.

Additionally or alternatively, calcium hydroxide (e.g., Ca(OH)₂) may be present in the manure ash product in an amount of at least about 1.0 wt. %, at least about 5.0 wt. %, at least about 7.0 wt. %, or at least about 10 wt. %. Additionally or alternatively, calcium hydroxide (e.g., Ca(OH)₂) may be present in the manure ash product in an amount of about 1.0 wt. % to about 10 wt. %, about 1.0 wt. % to about 7.0 wt. %, or about 1.0 wt. % to about 5.0 wt. %.

Additionally or alternatively, potassium hydroxide (e.g., KOH) and potassium carbonates (e.g., K₂CO₃), separately or together, may be present in the manure ash product in an amount of at least about 3.0 wt. %, at least about 5.0 wt. %, at least about 7.0 wt. %, at least about 10 wt. %, at least about 15 wt. % or at least about 20 wt. %. Additionally or alternatively, potassium hydroxide (e.g., KOH) and potassium carbonates (e.g., K₂CO₃), separately or together, may be present in the manure ash product in an amount of about 3.0 wt. % to about 20 wt. %, about 3.0 wt. % to about 15 wt. % or about 5.0 wt. % to about 15 wt. %.

Additionally or alternatively, fluorine may be present in the manure ash product in a low amount, e.g., less than or equal to about 5.0 wt. %, less than or equal to about 3.0 wt. %, less than or equal to about 2.0 wt. %, less than or equal to about 1.0 wt. %, or less than or equal to about 0.5 wt. % or substantially 0.0 wt. %.

In various aspects, the manure ash product may have a basic pH. For example, the manure ash product may have a pH of greater than about 7, greater than or equal to about 8, greater than or equal to about 9, greater than or equal to about 10, greater than or equal to about 11, greater than or equal to about 12, greater than or equal to about 13, or about 14. In particular, the manure ash product may have a pH of greater than or equal to about 9, greater than or equal to about 10, greater than or equal to about 11, or greater than or equal to about 13.

Additionally or alternatively, the manure ash product may have a pH of about 7, less than or equal to about 8, less than or equal to about 9, less than or equal to about 10, less than or equal to about 11, less than or equal to about 12, less than or equal to about 13, or less than or equal to about 14. In particular, the manure ash product may have a pH of less than or equal to about 14, less than or equal to about 13, or less than or equal to about 12.

Additionally or alternatively, the manure ash product may have a pH of about 7 to about 14, about 8 to about 14, about 9 to about 14, about 9 to about 13 or about 10 to about 13 or about 8 to about 10.

In various aspects, the method may further comprise determining the pH of the manure ash product and/or the amount of calcium phosphate, calcium, phosphorus, and/or potassium in the manure ash product. Advantageously, when the pH of the manure ash product is determined to be between about 10 and about 13 and the manure ash product comprises calcium phosphate, at least about 5.0 wt. % phosphorous, and/or at least about 10.0 wt. % calcium, the manure ash product is capable for use as the feed ingredient for ruminants. Thus, in such a situation, no further steps are necessary to adjust the pH of the manure ash product and/or adjust the amount of the amount of calcium phosphate, calcium, phosphorus, and/or potassium in the manure ash product.

Additionally or alternatively, when the pH of the manure ash product is determined to be less than about 10 (e.g., between about 8 and 10) and the manure ash product comprises calcium phosphate, at least about 5.0 wt. % phosphorous, and/or at least about 10.0 wt. % calcium, the manure ash product is capable for use as the feed ingredient for poultry. Thus, in such a situation, no further steps are necessary to adjust the pH of the manure ash product and/or adjust the amount of the amount of calcium phosphate, calcium, phosphorus, and/or potassium in the manure ash product.

C. Contacting the Manure Ash Product with a Neutralizing Agent

Optionally, the manure ash product having a pH as described above (e.g., greater than about 9 or greater than about 10) may be adjusted to produce the feed ingredient. Adjusting the pH of the manure ash product may comprise contacting the manure ash product with at least one neutralizing agent in a sufficient amount to produce a feed ingredient for livestock having a suitable pH, e.g., less than or equal to about 13 or less than or equal to about 10. For example, when the pH of the manure ash product is greater than about 13, the manure ash product may be contacted with at least one neutralizing agent in a sufficient amount to produce a feed ingredient for livestock having a pH below 13 (e.g. about 10 to about 13) such that the feed ingredient can be used for ruminants. Additionally or alternatively, when the pH of the manure ash product is greater than about 10 (e.g., ˜11, ˜12, ˜13), the manure ash product may be contacted with at least one neutralizing agent in a sufficient amount to produce a feed ingredient for livestock having a pH of less than or equal to about 10 (e.g. about 8 to about 10) such that the feed ingredient can be used for poultry. Examples of suitable neutralizing agents include, but are not limited to water and/or inorganic acid. Exemplary inorganic acids include, but are not limited to phosphoric acid, sulfuric acid, hydrochloric acid and a combination thereof.

In one embodiment, contacting the manure ash product with at least one neutralizing agent may comprise mixing water with the manure ash product to produce the feed ingredient and removing the water from the feed ingredient. Water may be mixed with the manure ash product in one or more neutralization steps (e.g. 1 to 10 neutralization steps, 1 to 8 neutralization steps, 1 to 5 neutralization steps, 1 to 3 neutralization steps). For example, the manure ash product may be mixed with water in a first neutralization step to produce a first neutralized product. The first neutralized product may then be mixed with water in a second neutralization to produce the feed ingredient, as shown in FIG. 1.

Water may be mixed with the manure ash product in a batch or continuous process to create a slurry with a manure ash product:water mass ratio of at least about 1:5, at least about 1:10, at least about 1:20 or at least about 1:50, wherein the alkalinity (e.g., potassium hydroxide (e.g., KOH), potassium carbonates (e.g., K₂CO₃)) in the manure ash product is water soluble and may be removed from the manure ash product thereby lowering the pH of the manure ash product to produce a feed ingredient. Optionally, the water may be heated to a temperature of between about 150° F. and about 190° F. which may decrease the amount of time needed to adjust the pH of the manure ash product to produce the feed ingredient. Additionally, moderate agitation of the slurry may also optionally be performed to decrease timing of the process and/or increase uniformity in the resultant feed ingredient. The adjusting step may be completed within about 1 hour (e.g., within about 40 minutes) during a batch process. The water may be removed from the feed ingredient using any suitable process, such as a decanting or a vacuum filter process.

A functionally equivalent continuous process can also be used that combines the introduction of water and the neutralizing agent as the manure ash product is being conveyed.

Additionally or alternatively, as shown in FIG. 1, the manure ash product may be ground or milled prior to contacting it with the neutralizing agent to improve uniformity, reduce size and/or blendability, and/or to increase surface area of the manure ash product which improves its performance during the adjusting step.

In either the batch or continuous process, the alkalinity (pH) of the water being removed may be monitored to determine when the adjusting step is complete. If needed, an optional additional (e.g., second, third, fourth, etc.) adjusting step involving the same or a different concentration of water. Once the water is removed from the feed ingredient, the feed ingredient may be dried by any suitable means, e.g., a paddle dryer, a rotary drum vacuum filter or a functionally similar device, to a moisture level of less than about 5.0 wt. % water, less than about 3.0 wt. % water, less than about 1.0 wt. % water or less than about 0.50 wt. % water.

Additionally or alternatively, the water removed from the feed ingredient comprises potassium carbonate and/or potassium hydroxide. Thus, the method may further comprise recovering potassium carbonate and/or potassium hydroxide from the water removed from the livestock feed product by any suitable means. Any suitable process for recovering potassium carbonate and/or potassium hydroxide may be performed, such as, but not limited to dehydration, combining potassium hydroxide with carbon dioxide or carbonic acid to produce potassium carbonate, or crystallization.

Additionally, the manure ash product may be mixed with an inorganic acid as described above. The inorganic acid may be mixed with the manure ash product before or after the manure ash product is mixed with water. Alternately, the inorganic acid may be mixed with the water to form a mixture, which is then contacted with the manure ash product, as shown in FIG. 1. In the event that the inorganic acid is phosphoric acid, contacting the manure ash product with phosphoric acid may also increase the phosphorus content of the feed ingredient. The amount of inorganic acid added can be as much as about 0.04 pounds of inorganic acid (e.g., phosphoric acid) per pound of manure ash product, in the event that phosphoric acid is the selected acid.

In another embodiment, contacting the manure ash product with the at least one neutralizing agent comprises mixing a suitable amount of an inorganic acid with the manure ash product to produce the feed ingredient in one or more neutralization steps. In the event that the inorganic acid is phosphoric acid, contacting the manure ash product with phosphoric acid may also increases the phosphorus content of the feed ingredient as described above. The amount of inorganic acid added can be as much as about 0.04 pounds of inorganic acid (e.g., phosphoric acid) per pound of manure ash product, in the event that phosphoric acid is the selected acid.

D. Adjusting Minerals in Manure Ash Product

Additionally or alternatively, the method may further comprise adjusting the amount of minerals described herein in the manure ash product. For example, the amount of one or more of calcium phosphate, calcium, phosphorus, and potassium in the manure ash product may be adjusting to produce the feed ingredient. For example, if the amount of calcium phosphate is too low additional sources of calcium phosphate (e.g. hydroxyapatite, monocalcium phosphate, dicalcium phosphate, tricalcium phosphate) may be added or blended with the manure ash product to produce the feed ingredient. Additionally or alternatively, a further manure ash product and/or further minerals, such as, but not limited to the mineral compounds described herein and sources of those minerals may be mixed with the manure ash product to the manure ash product to produce a feed ingredient comprising at least about 5.0 wt. % phosphorous, and/or at least about 10.0 wt. % calcium.

E. Feed Ingredient for Livestock

In various aspects, the methods described herein produce a feed ingredient with a suitable pH and suitable amounts of minerals. In particular, the feed ingredient produced herein may have a pH of less than or equal to about 13, less than or equal to about 12, less than or equal to about 11, less than or equal to about 10, less than or equal to about 9, less than or equal to about 8, or less than or equal to about 7. In particular, the feed ingredient has a pH of less than or equal to about 13, less than or equal to about 10, less than or equal to about 9, or less than or equal to about 8. Additionally or alternatively, the feed ingredient has a pH of about 7 to about 13, about 8 to about 13, about 8 to about 10, about 8 to about 9 or about 10 to about 13. As discussed above, a feed ingredient with a pH of about 10 to about 13 is suitable for ruminant feed. A higher pH may be suitable of ruminant feed because ruminants may be fed a high-energy diet where acidosis can occur necessitating the feeding of a buffer additive, such as the above-described feed ingredient. A feed ingredient with a pH of greater than equal to 8 and less than about 10 is suitable for poultry feed because it has be found that a higher pH (e.g., greater than or equal to 10) can cause minor lesions in the oral cavity of poultry.

Additionally or alternatively, the feed ingredient may comprises calcium phosphate that complies with the AAFCO definition 57.134, wherein the calcium phosphate must be produced by either calcining, fusing, precipitating, or reacting as described above. For example, the thermal reaction processes described herein can be understood as either calcining or reacting where calcining is defined as “to heat (a substance) to a high temperature but below the melting or fusing point, causing loss of moisture, reduction or oxidation, and the decomposition of carbonates and other compounds” and the reaction is either thermochemical (e.g., through gasification) or chemical (e.g., through the addition of water or inorganic acid). Additionally or alternatively, the feed ingredient may comprises calcium phosphate that complies with 21 CFR §182.8217.

Additionally or alternatively, the minerals present in the feedstock ingredient comply with the U.S. Food and Drug Administration definitions of materials that are Generally Recognized as Safe (GRAS) according to 21 CFR §182 and 21 CFR §184.

Additionally or alternatively, the feed ingredient may comprise calcium, phosphorous, potassium and magnesium.

Additionally or alternatively, the feed ingredient may comprise calcium in an amount of at least about 10 wt. %, at least about 11 wt. %, at least about 15 wt. %, at least about 20 wt. %, at least about 25 wt. %, at least about 30 wt. %, at least about 40 wt. % or at least about 50 wt. %. Additionally or alternatively, the manure ash product may comprise calcium in an amount of about 10 wt. % to about 50 wt. %, about 10 wt. % to about 40 wt. %, about 11 wt. % to about 40 wt. %, about 20 wt. % to about 40 wt. % or about 30 wt. % to about 40 wt. %.

Additionally or alternatively, the feed ingredient may comprise phosphorus in an amount of at least about 5.0 wt. %, at least about 6.0 wt. %, at least about 7.0 wt. %, at least about 10 wt. %, at least about 12 wt. % or at least about 15 wt. %. Additionally or alternatively, the feed ingredient may comprise phosphorus in an amount of about 5.0 wt. % to about 15 wt. %, 6.0 wt. % to about 15 wt. %, about 5.0 wt. % to about 12 wt. % or about 5.0 wt. % to about 10 wt. %.

Additionally or alternatively, the feed ingredient may comprise potassium in an amount of at least about 1.0 wt. %, at least about 2.0 wt. %, at least about 3.0 wt. %, at least about 5.0 wt. %, at least about 7.0 wt. %, at least about 7.5 wt. %, at least about 10 wt. %, or at least about 12 wt. %. Additionally or alternatively, the feed ingredient may comprise potassium in an amount of less than about 1.0 wt. %, less than about 2.0 wt. %, less than about 3.0 wt. %, less than about 5.0 wt. %, less than about 7.0 wt. %, less than about 7.5 wt. %, less than about 10 wt. %, or less than about 12 wt. %. Additionally or alternatively, the feed ingredient may comprise potassium in an amount of about 1.0 wt. % to about 12 wt. %, about 3.0 wt. % to about 10 wt. %, about 5.0 wt. % to about 10 wt. % or about 7.5 wt. % to about 12 wt. %.

Additionally or alternatively, the feed ingredient may comprise magnesium in an amount of at least about 0.50 wt. % at least about 1.0 wt. %, at least about 3.0 wt. %, at least about 5.0 wt. %, at least about 7.0 wt. %, or at least about 10 wt. %. Additionally or alternatively, the feed ingredient may comprise magnesium in an amount of about 0.50 wt. % to about 10 wt. %, about 1.0 wt. % to about 7.0 wt. % or about 0.50 wt. % to about 5.0 wt. %.

Additionally or alternatively, the feed ingredient may comprise various mineral compounds, such as but not limited to mineral compounds described herein. For example, the feed ingredient may comprise calcium phosphates (e.g., Ca₅(PO₄)₃(OH)₂ (hydroxyapatite), Ca(H₂PO₄)₂ (monocalcium phosphate), CaHPO₄ (dicalcium phosphate), Ca₃(PO₄)₂ (tricalcium phosphate)), calcium carbonates (e.g. CaCO₃ (calcite)), sorosilicates (e.g., Ca₂MgSi₂O₇ (akermanite)), potassium chlorides (e.g., KCl (sylvite)), potassium sulfates (e.g., K₂SO₄ (arcanite)), calcium oxides (e.g., CaO (lime)), magnesium oxides (e.g., MgO (periclase)), calcium hydroxide (e.g., Ca(OH)₂ (portlandite)), potassium hydroxide (e.g., KOH) potassium carbonates (e.g., K₂CO₃) and combinations thereof.

Calcium phosphate (e.g., Ca₅(PO₄)₃(OH)₂, Ca(H₂PO₄)₂, CaHPO₄, Ca₃(PO₄)₂) may be present in the feed ingredient in an amount of at least about 10 wt. %, at least about 20 wt. %, at least about 30 wt. %, at least about 35 wt. %, at least about 40 wt. % or at least about 45 wt. %. Additionally or alternatively, calcium phosphate (e.g., Ca₅(PO₄)₃(OH)₂, Ca(H₂PO₄)₂, CaHPO₄, Ca₃(PO₄)₂) may be present in the feed ingredient in an amount of about 10 wt. % to about 45 wt. %, about 20 wt. % to about 45 wt. %, about 30 wt. % to about 45 wt. %, about 35 wt. % to about 45 wt. %, or about 35 wt. % to about 40 wt. %.

Additionally or alternatively, calcium carbonate (e.g. CaCO₃) may be present in the feed ingredient in an amount of at least about 20 wt. %, at least about 25 wt. %, at least about 30 wt. %, at least about 35 wt. % or at least about 40 wt. %. Additionally or alternatively, calcium carbonate (e.g. CaCO₃) may be present in the feed ingredient in an amount of about 20 wt. % to about 40 wt. %, about 20 wt. % to about 35 wt. %, or about 25 wt. % to about 35 wt. %.

Additionally or alternatively, sorosilicate (e.g., Ca₂MgSi₂O₇) may be present in the feed ingredient in an amount of at least about 1.0 wt. %, at least about 3.0 wt. %, at least about 5.0 wt. %, at least about 7.0 wt. % or at least about 10 wt. %. Additionally or alternatively, sorosilicate (e.g., Ca₂MgSi₂O₇) may be present in the feed ingredient in an amount of about 1.0 wt. % to about 10 wt. %, about 1.0 wt. % to about 7.0 wt. %, or about 1.0 wt. % to about 5.0 wt. %.

Additionally or alternatively, potassium sulfate (e.g., K₂SO₄) may be present in the feed ingredient in an amount of at least about 0.50 wt. %, at least about 1.0 wt. %, at least about 3.0 wt. %, or at least about 5.0 wt. %. Additionally or alternatively, potassium sulfate (e.g., K₂SO₄) may be present in the feed ingredient in an amount of about 0.50 wt. % to about 5.0 wt. %, about 0.50 wt. % to about 3.0 wt. %, or about 1.0 wt. % to about 3.0 wt. %.

Additionally or alternatively, calcium oxide (e.g., CaO) may be present in the feed ingredient in an amount of at least about 3.0 wt. %, at least about 5.0 wt. %, at least about 7.0 wt. %, at least about 10 wt. % or at least about 15 wt. %. Additionally or alternatively, calcium oxide (e.g., CaO) may be present in the feed ingredient in an amount of about 3.0 wt. % to about 15 wt. %, about 5.0 wt. % to about 15 wt. %, or about 7.0 wt. % to about 15 wt. %.

Additionally or alternatively, magnesium oxide (e.g., MgO) may be present in the feed ingredient in an amount of at least about 1.0 wt. %, at least about 5.0 wt. %, at least about 7.0 wt. %, or at least about 10 wt. %. Additionally or alternatively, magnesium oxide (e.g., MgO) may be present in the feed ingredient in an amount of about 1.0 wt. % to about 10 wt. %, about 1.0 wt. % to about 7.0 wt. %, or about 1.0 wt. % to about 5.0 wt. %.

Additionally or alternatively, calcium hydroxide (e.g., Ca(OH)₂) may be present in the feed ingredient in an amount of at least about 1.0 wt. %, at least about 5.0 wt. %, at least about 7.0 wt. %, or at least about 10 wt. %. Additionally or alternatively, calcium hydroxide (e.g., Ca(OH)₂) may be present in the feed ingredient in an amount of about 1.0 wt. % to about 10 wt. %, about 1.0 wt. % to about 7.0 wt. %, or about 1.0 wt. % to about 5.0 wt. %.

Additionally or alternatively, potassium hydroxide (e.g., KOH) and potassium carbonates (e.g., K₂CO₃), separately or together, may be present in the feed ingredient in an amount of at least about at least about 3.0 wt. %, at least about 5.0 wt. %, at least about 7.0 wt. %, at least about 10 wt. %, at least about 15 wt. % or at least about 20 wt. %. Additionally or alternatively, potassium hydroxide (e.g., KOH) and potassium carbonates (e.g., K₂CO₃), separately or together, may be present in the feed ingredient in an amount of less than about 3.0 wt. %, less than about 5.0 wt. %, less than about 7.0 wt. %, less than about 10 wt. %, less than about 15 wt. % or less than about 20 wt. %. Additionally or alternatively, potassium hydroxide (e.g., KOH) and potassium carbonates (e.g., K₂CO₃), separately or together, may be present in the feed ingredient in an amount of about 3.0 wt. % to about 20 wt. %, about 3.0 wt. % to about 15 wt. % or about 5.0 wt. % to about 15 wt. %.

Additionally or alternatively, fluorine may be present in the feed ingredient in a low amount, e.g., less than or equal to about 5.0 wt. %, less than or equal to about 3.0 wt. %, less than or equal to about 2.0 wt. %, less than or equal to about 1.0 wt. %, or less than or equal to about 0.5 wt. % or substantially 0.0 wt. %.

In particular, the feed ingredient may comprise calcium phosphate; calcium in an amount of at least about 10 wt. %; phosphorous in an amount of at least about 5.0 wt. %, wherein the feed ingredient has a pH of less than about 13 or less than about 10. Additionally or alternatively, the feed ingredient may comprise potassium in an amount of at least about 5.0 wt. %

F. Optional Steps

Additionally or alternatively, the methods described herein may further comprise drying the feed ingredient by any suitable means, e.g., a paddle dryer, a rotary drum vacuum filter or the like.

Additionally or alternatively, the feed ingredient may undergo grinding.

Additionally or alternatively, the feed ingredient may be blended to reduce variation in composition for phosphorus, calcium, potassium, or magnesium. The feed ingredient produced, prior to any further blending, varies depending on the composition of livestock manure. The livestock manure composition is a function of diet. Within specific applications, such as egg-laying poultry, there can be about a 25 wt. % variation in the content of target mineral nutrients. Blending production lots can be used to achieve the uniformity needed to market a standard commercial product. Between applications (e.g. comparing egg-layer chickens and broiler chickens), there can be a greater variation (i.e. calcium being as low as approximately 11 wt. % for broiler chickens and as high as approximately 40 wt. % for egg-layer chickens). The ranges of manure ash product and/or feed ingredient, prior to blending, can be for phosphorus from approximately 5 wt. % to approximately 12 wt. %, for calcium from approximately 11 wt. % to approximately 40 wt. %, for potassium from approximately 5 wt. % to approximately 10 wt. %, for magnesium from approximately 2 wt. % to approximately 4 wt. %, and for sodium from approximately 1 wt. % to approximately 1.5 wt. %. Further blending can be achieved by adding in additional manure ash product with desired levels of minerals are adding in various mineral compounds, such as the mineral compounds described herein.

Additionally or alternatively, the feed ingredient may be further heated at temperatures of at least about 175° F. for a suitable amount of time (e.g., not less than about 10 seconds) or radiating for a suitable amount of time to kill pathogens in the feed ingredient.

Additionally or alternatively, the feed ingredient may be incorporated or blended into a livestock feed product, such as a ruminant feed product and/or a poultry feed product with or without other feed ingredients.

In another embodiment, a method for producing a feed ingredient for livestock is provided herein. The method may comprise: optionally, selecting a manure ash product a described herein comprising calcium phosphate as described herein; determining the pH of the manure ash product to produce the feed ingredient as described herein; optionally, determining the amount of calcium phosphate, calcium, phosphorus, and/or potassium in the manure ash product as described herein; optionally, adjusting the pH of the manure ash product as described herein and/or optionally, adjusting as described herein the amount of one or more of calcium phosphate, calcium, phosphorus, and potassium in the manure ash product to produce the feed ingredient comprising at least about 5.0 wt. % phosphorous, and at least about 10.0 wt. % calcium.

In another embodiment, a method for producing a feed ingredient for livestock is provided herein. The method may comprise contacting a manure ash product as described herein having a pH of greater than about 10 or greater than about 13 with at least one neutralizing agent in a sufficient amount to produce the feed ingredient for livestock having a pH of less than or equal to about 10, wherein the manure ash product is produced from a thermal reaction of livestock manure and wherein the feed ingredient comprises calcium in an amount of at least about 10 wt. %; phosphorous in an amount of at least about 5.0 wt. %; and potassium in an amount of at least about 5.0 wt. %.

### III. FEED INGREDIENT

In another embodiment, a feed ingredient produced by the methods described herein is provided.

In another embodiment, a feed ingredient for livestock is provided. The feed ingredient may comprise the minerals and compounds as described herein. In particular, the feed ingredient may comprise: comprise calcium phosphate; calcium in an amount of at least about 10 wt. %, at least about 20 wt. % or at least about 30 wt. %; phosphorous in an amount of at least about 5.0 wt. %, wherein the feed ingredient has a pH of less than about 13 or less than about 10. Additionally or alternatively, the feed ingredient may comprise potassium in an amount of at least about 1.0 wt. %, at least about 5.0 wt. % or at least about 7.5 wt. %

### IV. FURTHER EMBODIMENTS

The invention can additionally or alternately include one or more of the following embodiments.

### Embodiment 1

A method for producing a feed ingredient for livestock, wherein the method comprises: thermally reacting livestock manure to produce a manure ash product comprising calcium phosphate; determining the pH of the manure ash product to produce the feed ingredient (e.g., comprising at least about 5.0 wt. % phosphorous, and at least about 10.0 wt. % calcium); optionally, determining the amount of calcium phosphate, calcium, phosphorus, and/or potassium in the manure ash product; optionally, adjusting the pH of the manure ash product and/or optionally, adjusting the amount of one or more of calcium phosphate, calcium, phosphorus, and potassium in the manure ash product to produce the feed ingredient comprising at least about 5.0 wt. % phosphorous, and at least about 10.0 wt. % calcium.

### Embodiment 2

A method for producing a feed ingredient for livestock, wherein the method comprises: determining the pH of the manure ash product to produce the feed ingredient (e.g., comprising at least about 5.0 wt. % phosphorous, and at least about 10.0 wt. % calcium); optionally, determining the amount of calcium phosphate, calcium, phosphorus, and/or potassium in the manure ash product; optionally, adjusting the pH of the manure ash product and/or optionally, adjusting the amount of one or more of calcium phosphate, calcium, phosphorus, and potassium in the manure ash product to produce the feed ingredient comprising at least about 5.0 wt. % phosphorous, and at least about 10.0 wt. % calcium, and at least about 7.5 wt. % potassium.

### Embodiment 3

A method for producing a feed ingredient for livestock, wherein the method comprises: contacting a manure ash product having a pH of greater than about 10 or greater than about 13 with at least one neutralizing agent in a sufficient amount to produce the feed ingredient for livestock having a pH of less than or equal to about 10, wherein the manure ash product is produced from a thermal reaction of livestock manure and wherein the feed ingredient comprises calcium in an amount of at least about 10 wt. % and phosphorous in an amount of at least about 5.0 wt. %.

### Embodiment 4

The method of embodiment 1 or 2, wherein when pH of the manure ash product is determined to be between about 10 and about 13 and the manure ash product comprises at least about 5.0 wt. % phosphorous, and at least about 10 wt. % calcium, the manure ash product is capable for use as the feed ingredient for ruminants and/or when pH of the manure ash product is determined to be less than about 10 and the manure ash product comprises at least about 5.0 wt. % phosphorous, and at least about 10.0 wt. % calcium, the manure ash product is capable for use as the feed ingredient for poultry.

### Embodiment 5

The method of embodiment 1 or 2, further comprising adjusting the pH of the manure ash product comprises contacting the manure ash product with at least one neutralizing agent in a sufficient amount to produce the feed ingredient having a pH of less than or equal to about 13 or a pH of less than or equal to about 10.

### Embodiment 6

The method of any one of the previous embodiments, wherein the neutralizing agent is water, an inorganic acid (e.g., phosphoric acid, sulfuric acid, hydrochloric acid or a combination thereof or a combination thereof).

### Embodiment 7

The method of any one of the previous embodiments, wherein contacting the manure ash product with the at least one neutralizing agent comprises mixing water, and optionally an inorganic acid, with the manure ash product to produce the feed ingredient and removing the water from the feed ingredient and/or contacting the manure ash product with the at least one neutralizing agent comprises mixing a suitable amount of an inorganic acid with the manure ash product to produce the feed ingredient.

### Embodiment 8

The method of any one of the previous embodiments, wherein the water removed from the feed ingredient comprises potassium carbonate, potassium hydroxide or a combination thereof and/or the method further comprises recovering potassium carbonate, potassium hydroxide or a combination thereof from the water removed from the feed ingredient.

### Embodiment 9

The method of any one of the previous embodiments, further comprising adjusting the amount of one or more of calcium, phosphorus, and potassium in the manure ash product to produce the feed ingredient comprising at least about 5.0 wt. % phosphorous, and at least about 10 wt. % calcium.

### Embodiment 10

The method of any one of the previous embodiments, wherein the feed ingredient comprises calcium phosphate in accordance with AAFCO definition 57.134 or with 21 CFR §182.8217.

### Embodiment 11

The method of any one of the previous embodiments, wherein thermally reacting the livestock manure or thermal reaction of the livestock manure is a process selected from the group consisting of gasification, combustion, torrefaction, pyrolysis, and a combination thereof.

### Embodiment 12

The method of any one of the previous embodiments, wherein gasification of the livestock manure is performed at a temperature of about 600° F. to about 1500° F. in the presence of flue gas and air.

### Embodiment 13

The method of any one of the previous embodiments, wherein the manure ash product comprises mineral compounds selected from the group consisting of a calcium-containing compound, a phosphorus-containing compound, a potassium-containing compound, a magnesium-containing compound, and a combination thereof, optionally wherein the mineral compounds are selected from the group consisting of Ca₅(PO₄)₃(OH)₂, CaCO₃, Ca₂MgSi₂O₇, KCl, K₂SO₄, CaO, MgO, Ca(OH)₂, KOH, K₂CO₃ and a combination thereof.

### Embodiment 14

The method of any one of the previous embodiments, wherein the manure ash product comprises: calcium in an amount of at least about 10 wt. %; phosphorous in an amount of at least about 5.0 wt. %; and/or potassium in an amount of at least about 5.0 wt. %.

### Embodiment 15

A feed ingredient for livestock produced by the method of any one of the previous embodiments.

### Embodiment 16

A feed ingredient for livestock comprising: calcium phosphate; calcium in an amount of at least about 10 wt. %; phosphorous in an amount of at least about 5.0 wt. %; optionally, potassium in an amount of at least about 5.0 wt. %, wherein the feed ingredient has a pH of less than about 13 or less than about 10.

What is claimed is:

1. A method for producing a feed ingredient for livestock, wherein the method comprises:
thermally reacting livestock manure to produce a manure ash product comprising calcium phosphate; and
determining pH of the manure ash product to produce the feed ingredient comprising calcium phosphate.

2. The method of claim 1, wherein the feed ingredient comprises:
at least about 5.0 wt. % phosphorous; and
at least about 10.0 wt. % calcium.

3. The method of claim 1, wherein when pH of the manure ash product is determined to be between about 10 and about 13 and the manure ash product comprises at least about 5.0 wt. % phosphorous, and at least about 10.0 wt. % calcium, the manure ash product is capable for use as the feed ingredient for ruminants.

4. The method of claim 1, wherein when pH of the manure ash product is determined to be less than about 10 and the manure ash product comprises at least about 5.0 wt. % phosphorous, and at least about 10.0 wt. % calcium, the manure ash product is capable for use as the feed ingredient for poultry.

5. The method of claim 1 further comprising adjusting pH of the manure ash product by contacting the manure ash product with at least one neutralizing agent in a sufficient amount to produce the feed ingredient having a pH of less than or equal to about 13.

6. The method of claim 5, wherein the neutralizing agent is water, an inorganic acid or a combination thereof.

7. The method of claim 5, wherein contacting the manure ash product with the at least one neutralizing agent comprises mixing water with the manure ash product to produce the feed ingredient and removing the water from the feed ingredient.

8. The method of claim 7 further comprising recovering potassium carbonate, potassium hydroxide or a combination thereof from the water removed from the feed ingredient.

9. The method of claim 7 further comprising mixing the manure ash product with an inorganic acid.

10. The method of claim 5, wherein contacting the manure ash product with the at least one neutralizing agent comprises mixing a suitable amount of an inorganic acid with the manure ash product to produce the feed ingredient.

11. The method of claim 1 further comprising adjusting the amount of one or more of calcium, phosphorus, and potassium in the manure ash product to produce the feed ingredient comprising at least about 5.0 wt. % phosphorous, and at least about 10.0 wt. % calcium.

12. The method of claim 1, wherein the feed ingredient comprises calcium phosphate in accordance with AAFCO definition 57.134 or with 21 CFR §182.8217.

13. The method of claim 1, wherein thermally reacting the livestock manure is a process selected from the group consisting of gasification, combustion, torrefaction, pyrolysis, and a combination thereof.

14. The method of claim 12, wherein gasification of the livestock manure is performed at a temperature of about 600° F. to about 1500° F. in the presence of flue gas and air.

15. The method of claim 1, wherein the manure ash product comprises:
calcium in an amount of at least about 10 wt. %;
phosphorous in an amount of at least about 5.0 wt. %; and
potassium in an amount of at least about 5.0 wt. %.

16. A method for producing a feed ingredient for livestock, wherein the method comprises:
determining pH of a manure ash product comprising calcium phosphate to produce the feed ingredient comprising calcium phosphate.

17. The method of claim 1, wherein the feed ingredient comprises:
at least about 5.0 wt. % phosphorous; and
at least about 10.0 wt. % calcium.

18. The method of claim 16 further comprising adjusting pH of the manure ash product by contacting the manure ash product with at least one neutralizing agent in a sufficient amount to produce the feed ingredient having a pH of less than or equal to about 13.

19. The method of claim 18, wherein the neutralizing agent is water, an inorganic acid or a combination thereof.

20. The method of claim 18, wherein contacting the manure ash product with the at least one neutralizing agent comprises mixing water with the manure ash product to produce the feed ingredient and removing the water from the feed ingredient.

21. The method of claim 16 further comprising adjusting the amount of one or more of calcium, phosphorus, and potassium in the manure ash product to produce the feed ingredient comprising at least about 5.0 wt. % phosphorous, and at least about 10 wt. % calcium.

22. The method of claim 16, wherein the feed ingredient comprises calcium phosphate in accordance with AAFCO definition 57.134 or with 21 CFR §182.8217.

23. The method of claim 16, wherein the manure ash product is produced from a thermal reaction of livestock manure, wherein the thermal reaction is a process selected from the group consisting of gasification, combustion, torrefaction, pyrolysis, and a combination thereof.

24. A method for producing a feed ingredient for livestock, wherein the method comprises:
contacting a manure ash product having a pH of greater than about 10 with at least one neutralizing agent in a sufficient amount to produce the feed ingredient for livestock having a pH of less or equal to than about 10,
wherein the manure ash product is produced from a thermal reaction of livestock manure and wherein the feed ingredient comprises calcium in an amount of at least about 10 wt. %; and phosphorous in an amount of at least about 5.0 wt. %.

25. The method of claim 24, wherein the calcium phosphate present in the livestock feed product is in accordance with AAFCO definition 57.134 or with 21 CFR §182.8217.

26. A feed ingredient for livestock produced by the method of claim 1.
